(19) United States
(12) Patent Application Publication
(10) Pub. No.: US 2006/0284422 A1
(43) Pub. Date: Dec. 21, 2006

(54) Rotatable coupling

(75) Inventor: Dennis Lunder, Mission Hills, CA (US)

Correspondence Address: Larry F. Gitlin;RAPKIN, GITLIN & BEAUMONT, Suite 1620, 21650 Oxnard Street, Woodland Hills, CA, 91367, US

(73) Assignee: VALTERRA PRODUCTS, INC.

(21) Appl. No.: 11/147,719

(22) Filed: Jun. 9, 2005

(51) Int. Cl. F16L 21/00

(52) U.S. Cl. 285/401; 285/402; 285/62

(57) ABSTRACT

A rotatable coupling assembly for facilitating the connection and separation of a waste discharge hose between a recreational vehicle waste discharge outlet and the inlet of an external waste disposal receptacle, including a first coupling with a first fitting having a generally cylindrical main body with a flanged portion. A second fitting is also provided and is adapted to slide along the main body until it approaches the first fitting. The second fitting has radial projections for lockingly engaging corresponding hook-like members of a mating fitting of a second coupling, or the converse. A similarly structured third or mating fitting is also provided. A flanged ring member with an annular seating surface joins with one end of the discharge hose to enable the mated components to be slidably disposed along the main body until they approach the second fitting. When the parts are engaged, as described, the second fitting, which, in one example, comprises radial projections in one coupling and the third fitting, which comprises mating hook-like members in the other coupling, may each freely rotate about the corresponding main body.

### BACKGROUND OF THE INVENTION

1. Field of the Invention

The present invention relates generally to the field of recreational vehicle waste management and, more particularly, to an improved coupling device for connecting and separating a flexible waste disposal hose between a recreational vehicle waste discharge outlet and the inlet of an external waste disposal receptacle, septic or sewer system.

2. Description of the Prior Art

Recreational vehicle devices for connecting the flexible waste disposal hoses from the vehicle to an external waste disposal receptacle usually underground, are well known in the prior art. Bayonet type fittings are commonly used to make the connections for this purpose, among many other available alternatives. A major problem with these types of couplings regards the connections where the hose joins the discharge outlet in the vehicle at one end and the commonly used L-shaped fitting that mates with the inlet of the external waste disposal receptacle at the other. Because these connections are fixed, difficulties are encountered when an individual engages the often typically long, large and cumbersome hose while attempting to guide the ends of the hose and, more particularly, the hose fittings, into the RV discharge outlet and the inlet openings of an external waste disposal receptacle, septic or sewer system, and then secure them. Among other factors, the weight and length of the hose and the degree to which the hose may have become twisted, kinked or coiled in the process of attempting to secure the connections, often makes the effort to manipulate and secure the hose ends an extremely tedious and challenging task.

Nothing known in the prior art teaches a device with the improvements of the present invention, specifically rotatable hose fittings that (1) provide the connection to the waste discharge outlet of a recreational vehicle at one end of the hose and to the inlet fitting for an external waste disposal receptacle, septic or sewer system at the other end; and (2) enables the hose to easily lock in its connections at both ends without having to struggle with an unwieldy kinked, twisted or coiled hose in the process. Thus, it becomes much less difficult than before to manipulate the joined components and connect and secure the hose assembly at both ends. Accordingly, there is a need for the present invention to address and resolve the differences among the devices of the prior art.

### SUMMARY OF THE INVENTION

In its preferred embodiment, the present invention provides a rotatable coupling assembly for facilitating the connection and separation of a waste discharge hose, which includes an opening at each end, between a recreational vehicle waste discharge outlet and the inlet of an external waste disposal receptacle, septic or sewer system. The assembly includes a coupling with a first fitting having a generally cylindrical main body with an outside surface, a first end, which is substantially aligned with the main body, and a second end, which includes a flanged portion. In addition, there is a second fitting having an inner edge, an outer edge, an outside surface, and an opening configured to fit over the first end of the first fitting. The second fitting is made to slide along the main body until the first end of the second fitting abuts the flanged portion of the first fitting. The second fitting has spaced apart radial projections for lockingly engaging corresponding hook-like members projecting from another fitting of a mating coupling. A flanged ring member with an annular seating surface having an opening with a diameter sized closely to the diameter of the second fitting opening and an attached hose end is adapted to be slidably disposed along the main body until it approaches in close or abutting relation to the second fitting.

In practice, the second fitting engages the first end of the first fitting and then is moved in slidable relation along the main body until the second fitting abuts the flanged portion of the first fitting. The annular seating surface of the flanged ring member is fixedly joined with one end of the hose, completely covering the hose end and any exposed protruding wires. These joined components then engage the first end of the first fitting and are slide along the main body, with the hose portion covering portions of the main body as it moves in a progressively sealed tight fixed relationship with the main body until the ring member approaches in close or abutting relation to the second fitting.

When the parts are engaged, as described, the second fitting, which comprises a series of radial projections in one coupling and corresponding hook-like members in the other, may freely rotate about the main body, which is connected to each end of the hose, to facilitate the operational efficiency of the coupling assembly.

Accordingly, it is an object of the present invention to provide a rotatable coupling assembly that facilitates the connection and separation of a waste discharge hose between a recreational vehicle waste discharge outlet and the inlet of an external waste disposal receptacle, septic or sewer system.

Another object of the present invention is to provide a rotatable coupling assembly that enables a waste discharge hose to more easily lock in its connections at either end without having to struggle with an unwieldy kinked, twisted or coiled hose in the process.

Still another object of the present invention is to provide a rotatable coupling assembly that includes components that fully contain any spill over of the adhesive bonding material securing the hose end to the assembly fitting, and protect against any exposed and potentially dangerous wire ends often protruding when the hose is connected to the assembly fitting.

Still another object of the present invention is to provide a rotatable coupling assembly that is easy and convenient to use and install.

Still another object of the present invention is to provide a rotatable coupling assembly that is cost effective and easy to manufacture.

Other objects and advantages of the present invention will become apparent in the following specifications when considered in light of the attached drawings wherein the preferred embodiment of the invention is illustrated.

### BRIEF DESCRIPTION OF THE DRAWINGS

FIG. 1 is an exploded view of components of the coupling assembly in accordance with the present invention.

FIG. 2 is an exploded view of certain other components of the coupling assembly in accordance with the present invention.

FIG. 3 is a perspective view of the ring fitting of the coupling assembly in accordance with the present invention.

FIG. 4 is a perspective view of one section of the coupling assembly, including a rotatable fitting, shown secured to a hose end in accordance with the present invention.

FIG. 5 is a perspective view of another section of the coupling assembly, including a rotatable fitting, shown secured to the opposite hose end in accordance with the present invention.

FIG. 6 is a perspective view of the coupling assembly shown attached at one end to an RV and at the other end to an external in ground waste disposal receptacle, septic or sewer system in accordance with the present invention.

FIG. 7 is a cross-sectional view of one section of the coupling assembly in accordance with the present invention.

FIG. 8 is a cross-sectional view of another section of the coupling assembly in accordance with the present invention.

FIG. 9 is an enlarged view of the section of the coupling assembly shown encircled as 9 in FIG. 6 in accordance with the present invention.

FIG. 10 is an enlarged view of the section of the coupling assembly shown encircled as 10 in FIG. 6 in accordance with the present invention.

### DETAILED DESCRIPTION OF THE PREFERRED EMBODIMENT

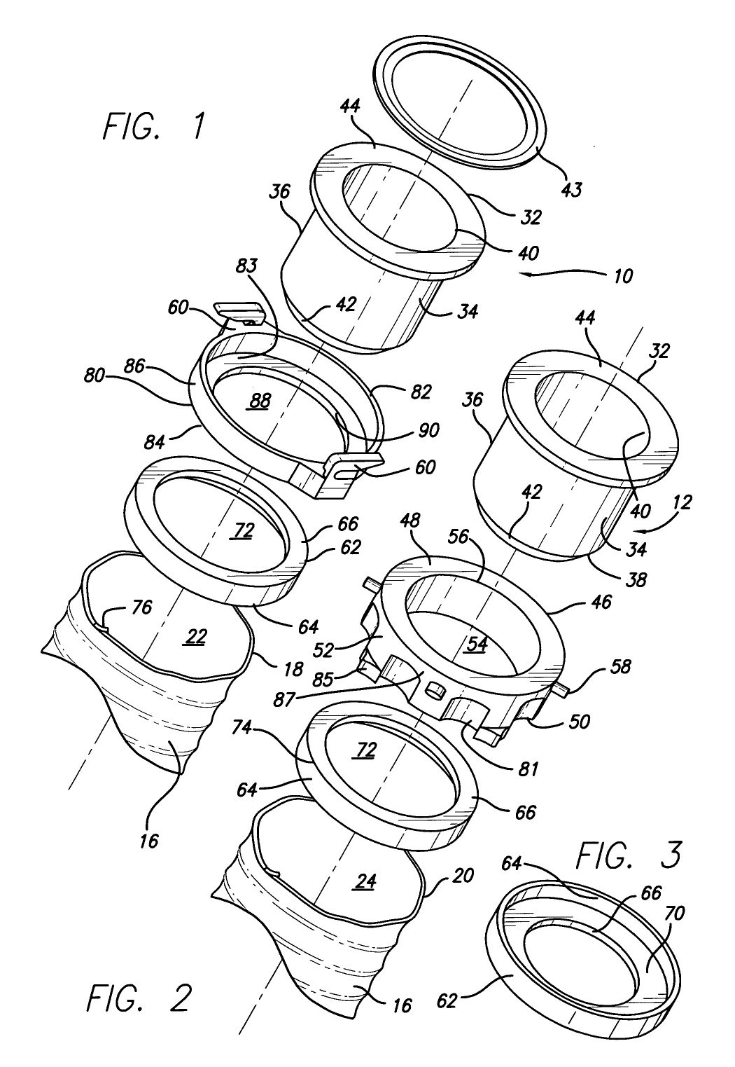

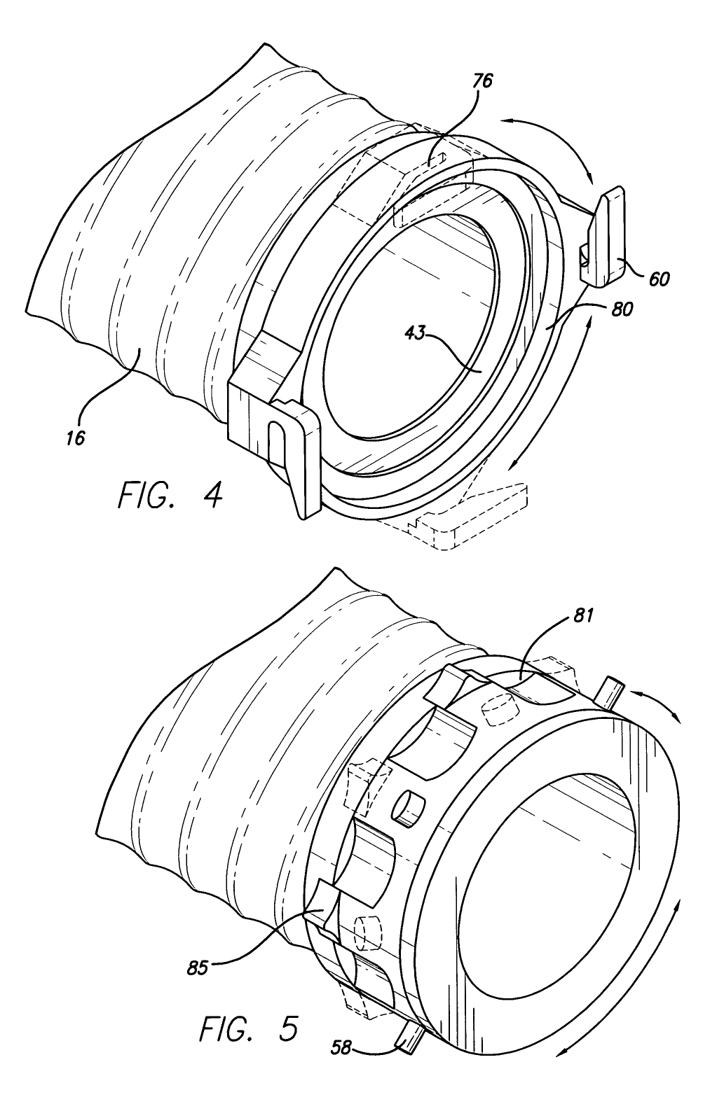

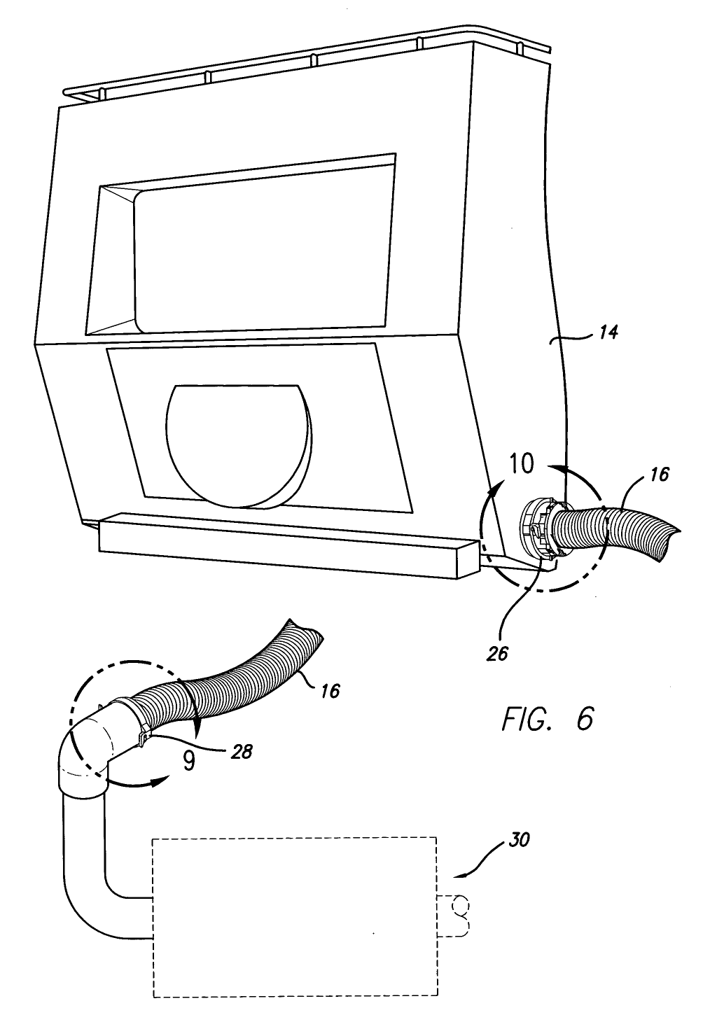

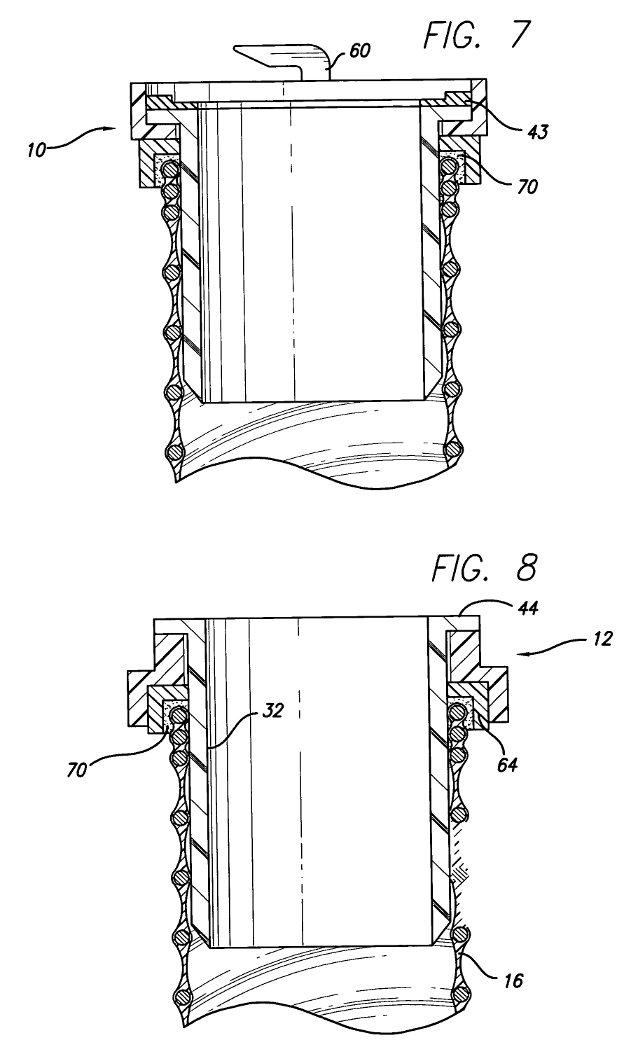

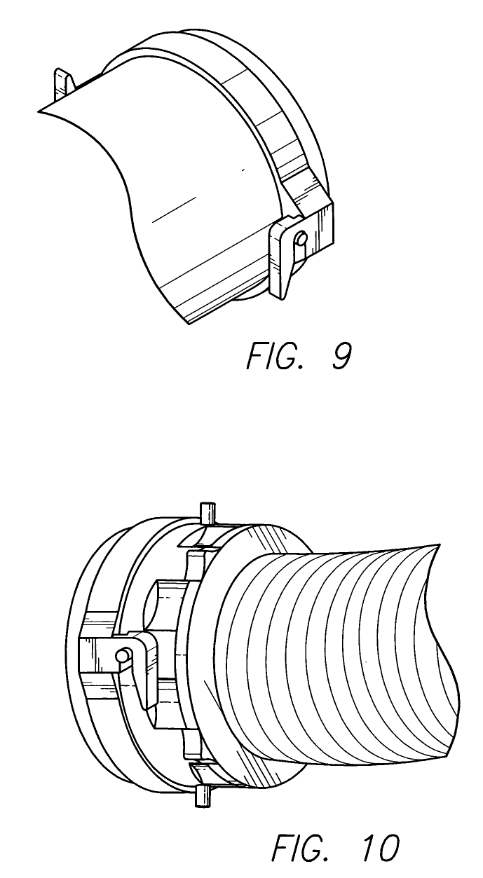

FIGS. 1 and 2 illustrate coupling sections of the preferred embodiment of the rotatable coupling assembly of the present invention, which are designated generally as coupling sections 10 and 12 for use in connection with a recreational vehicle 14.

Coupling sections 10, 12 are provided for facilitating the connection and separation of a waste discharge hose 16, which includes end portions 18, 20 and respective openings 22, 24, between a recreational vehicle discharge outlet 26 and inlet 28 of external waste disposal receptacle (or septic or sewer system) 30.

Coupling sections 10, 12 each comprises a first fitting member 32 having a main body 34 with a first outer diameter 36, a first end 38 and a second end 40. First end 38 is substantially axially aligned with main body 34, with a slight taper at edge 42. Second end 40 includes a flanged portion 44, though other suitable components or structural features may be employed to serve the same function. Affixed to flanged portion 44 in any suitable manner is gasket member 43 for sealing the connection between couplings.

Coupling section 10 includes a second fitting member 46 having inner edge 48, outer edge 50, outside surface 52 and opening 54 with a second diameter 56. Opening 54 is adapted to conform to and fit around first end 38 of first fitting member 32 and be moved in a slidable fashion along main body 34 until outer edge 50 comes close to or abuts flanged portion 44. Second fitting member 46 includes spaced apart radial projections 58 for engaging in locking relation corresponding hook-like members 60, such as those shown in third fitting member 80. Other types of locking components may also be suitable, such as, for example, components that snap fasten. Thumb depressions 81 and grips 85 radially projecting from surface 87 of second fitting member 80 are provided to facilitate the rotation of second fitting member 46.

Also provided is ring member 62 having a flanged portion 64 and inside edge 66. Between inside edge 64 and flanged portion 64 is annular seating surface 70. Opening 72 has a ring diameter 74 which is substantially equivalent to the size of second diameter 56, and is adapted to conform to and fit around tapered edge 42 of first end 38 and be moved in a slidable fashion along main body 34 until ring member 62 approaches in close or abutting relation outer edge 50 of second fitting member 46.

A separate third fitting member 80 is provided having an inner edge 82 with an inner seating surface 83, outer edge 84, outside surface 86 and opening 88 with a third diameter 90. Opening 88 is adapted to fit around first end 38 of a separate first fitting member 32 and, in a slidable fashion, be moved along main body 34 until inner seating surface 83 approaches close to or abuts flanged portion 44. Third fitting member 80 includes two or more spaced apart hook-like members 60 for engaging corresponding radial projections 58 in a locking relation.

Third fitting member 80 engages first fitting member 32 in generally the same manner that second fitting member 46 engages member 32 as described, for rotating spaced member 80 when lockingly mating it with corresponding radial projections 58.

In practice, hose end portion 18 is joined with ring member 62 using any suitable adhesive or similar material, or even a suitable mechanical means. Under normal circumstances, it is customary to use a strong adhesive to bond end portion 18 to hose 16. In the prior art, without the use of a ring or some type of flanged component to assist in a secure connection, end portion 18 would normally adhere to the main body of the first fitting member, and the glue or similar adhesive material would have a tendency to spill out from underneath the ends causing an unsightly and messy appearance and a reduction in bond strength. Protruding sharp wires, which can scratch or possibly cause a more serious injury, might also be exposed at the hose end. By employing ring member 62 as part of the assembly, the adhesive bonding agent and any exposed wire ends are fully covered over and contained. Thus, hose end portion 18, including any protruding exposed wire end 76, engages annular seating surface 70, where the two elements are securely joined, as described. Hose end portion 20 engages ring member 62 in the same manner. Joined by hose end portion 18 or 20, ring member 62 then engages main body 34 of first fitting member 32 at first end 38 and slips over tapered edge 42. Ring member 62 secured to hose 16 then slides along main body 34 with sections of hose 16 covering portions of the surface of main body 34 as it moves along in a progressively sealed tight friction fixed relationship with main body 34.

When the parts are engaged, as described, second fitting member 46 and/or third fitting 80, as the case may be, may freely rotate about main body 34 to facilitate the operational efficiency of the coupling assembly.

The rotatable coupling sections 10, 12, as described herein, can each be combined with a waste discharge hose 16 and connected to each of its end portions 18, 20 in one of several ways. For example, if second fitting member 46 with its spaced apart radial projections 58 is employed as a coupling component, the mating coupling component of coupling section 10, which may be attached to either the vehicle discharge outlet 26 or inlet 28 of external waste disposal receptacle 30, would need to include third fitting member 80 with its hook like members 82 to engage and lock the two coupling components. If third fitting member 80 with its hook-like members 82 is utilized at either end 18 or 20 of hose 16, then the fixture would need to be mated with an assembly that employs second fitting member 46 with its spaced apart radial projections 58.

Irrespective of the choice of arrangement, the ability for both second fitting member 46 and third fitting member 80 to freely rotate a full 360 degrees about a main body 34 in the process of extending and manipulating hose 16 between the RV and the external waste receptacle 30 to make the required connections is overall paramount.

The preferred material for producing the various components of the present invention is a resilient synthetic, such as plastic, through any suitable material may be used for this purpose. The size and shape of these components also are not a limitation, since the size of an RV or external waste disposal receptacle or even the volume of waste to be disposed of might dictate a need for a larger or possibly smaller assembly. Though an annular or rounded shape or configuration is desirable for the various components, any design that would permit the hose ends to maintain a tight seal and the second and third fitting members to freely rotate, as described herein, are considered to be an acceptable alternative to the preferred embodiment of the invention.

While the invention will be described in connection with a certain preferred embodiment, it is to be understood that it is not intended to limit the invention to that particular embodiment. Rather, it is intended to cover all alternatives, modifications and equivalents as may be included within the spirit and scope of the invention as defined by the appended claims.

1. A rotatable coupling assembly for facilitating the connection and separation of a waste discharge hose, said hose having end portions and an opening at either end, between a recreational vehicle waste discharge outlet and the inlet of an external waste disposal receptacle, comprising:
a first fitting having a main body with a first outer diameter, a first end and a second end, said first end being substantially axially aligned with said main body;
a second fitting having an inner edge, an outer edge, an outside surface, and an opening with a second diameter adapted to fit over said first end of said first fitting and slide along said main body until said inner edge comes close to or abuts said first fitting, said second fitting having spaced apart radial projections for engaging in a locking relation corresponding hook like members of a mating fitting;
a ring member with an annular seating surface, said seating surface being joined to one of said hose end portions, having an opening with a diameter substantially the same as said second diameter of said second fitting opening adapted to be slidably disposed along said main body until it approaches said second fitting in close or abutting relation; and,
wherein said second fitting engages said first end of said first fitting and is moved in slidable relation along said main body until said second fitting comes close to or abuts said second end of said first fitting, and said first end of said first fitting engages the opening formed by said joined ring member and hose end in a sealed-tight fixed relation enabling said second fitting to freely rotate about said main body.

2. A rotatable coupling assembly for facilitating the connection and separation of a waste discharge hose, said hose having end portions and an opening at either end, between a recreational vehicle discharge outlet and the inlet of an external waste disposal receptacle, comprising:
a first fitting having a main body with a first outer diameter, a first end and a second end, said first end being substantially axially aligned with said main body;
a second fitting having an inner edge, an outer edge, an outside surface, and an opening with a second diameter adapted to fit over said first end of said first fitting and slide along said main body until said inner edge comes close to or abuts said first fitting, said second fitting having two or more hook-like members integrally formed therewith for engaging in a locking relation corresponding radial projections of a mating fitting;
a ring member with an annular seating surface, said seating surface being joined to one of said hose end portions, having an opening with a diameter substantially the same as said second diameter of said second fitting opening adapted to be slidably disposed along said main body until it approaches said second fitting in close or abutting relation; and,
wherein said second fitting engages said first end of said first fitting in slidable relation along said main body until said second fitting comes close to or abuts said second end of said first fitting, and said first end of said first fitting engages the opening formed by said joined ring member and hose end in a sealed-tight fixed relation enabling said second fitting to freely rotate about said main body.

3. A rotatable coupling assembly for facilitating the connection and separation of a waste discharge hose, said hose having end portions and an opening at either end, between a recreational vehicle discharge outlet and the inlet of an external waste disposal receptacle, comprising:
a first fitting having a main body with a first outer diameter, a first end and a second end, said first end being substantially axially aligned with said main body and said second end having a stop member;
a second fitting having a first end and a second end and an opening with a second diameter adapted to fit over said first end of said first fitting and slide along said main body until said first end of said second fitting comes close to or engages said stop member, said second fitting having integrally formed hook-shape members for lockingly engaging radial projections of a mating fitting;
a flanged ring member having an opening with a diameter substantially the same as said second diameter adapted to be slidably disposed along said main body until said ring member approaches said second end of said second fitting in close or abutting relation; and,
wherein said second fitting engages said first end of said first fitting and is moved in slidable relation along said main body until said second fitting comes close to or engages said stop member, and said flanged portion of said ring memberjoins with one of said hose end portions to enable the joined hose end and ring member to engage said first end of said first fitting in a sealed-tight fixed relation, to enable laterally contained rotational movement of said second fitting about said main body.

4. A rotatable coupling assembly for facilitating the connection and separation of a waste discharge hose, said hose having end portions and an opening at either end, between a recreational vehicle discharge outlet and the inlet of an external waste disposal receptacle, comprising:
a first fitting having a main body with a first outer diameter, a first end and a second end, said first end being substantially axially aligned with said main body and said second end having a stop member;
a second fitting having a first end and a second end and an opening with a second diameter adapted to fit over said first end of said first fitting and slide along said main body until said first end of said second fitting comes close to or engages said stop member, said second fitting having spaced apart radial projections integrally formed therewith for lockingly engaging hook-like members of a mating fitting;
a flanged ring member having an opening with a diameter substantially the same as said second diameter adapted to be slidably disposed along said main body until it approaches said second end of said second fitting in close or abutting relation;
wherein said second fitting engages said first end of said first fitting and is moved in slidable relation along said main body until said second fitting comes close to or engages said stop member, and said flanged portion of said ring member joins with one of said hose end portions to enable the joined hose end and ring member to engage said first end of said first fitting in a sealed-tight fixed relation, to enable laterally contained rotational movement of said second fitting about said main body.

5. A rotatable coupling assembly for facilitating the connection and separation of a waste discharge hose between a recreational vehicle waste discharge outlet having a coupling member with a fitting and the inlet of an external waste disposal receptacle having a coupling member with a fitting, comprising:
said waste discharge hose having first and second end portions and an opening at either end;
at least two first fitting members each having a main body with a first outer diameter, a first end and a second end, and each said first end being substantially axially aligned with each said main body and each said second end having a flanged portion;
a second fitting having an inner edge, an outer edge, an outside surface, and an opening with a second diameter adapted to fit over said first end of one of said first fittings and slide along said main body until said inner edge comes close to or abuts said flanged portion of said first fitting, said second fitting having spaced apart radial projections on said outside surface for lockingly engaging corresponding hook-like members of a mating fitting;
a third fitting having an inner edge, an outer edge, an outside surface, and an opening with a third diameter adapted to fit over said first end of the other said first fitting and slide along said main body until said inner edge comes close to or abuts said flanged portion of said first fitting, said third fitting having two or more integrally formed hook-like members for lockingly engaging corresponding radial projections of a mating fitting;
at least two flanged ring members each having an annular seating surface and an opening with a diameter substantially the same as said second diameter and adapted to be slidably disposed along said main body of a separate said first fitting; and,
wherein each of said annular seating surfaces of said flanged ring members joins with one said hose end, said second fitting engages said first end of one of said first fittings and said third fitting engages said first end of the other said first fitting and both said second and third fittings, respectively, being movable in slidable relation along a said main body until each of said fittings comes close to or abuts said flanged portions of said respective first fitting, and said first end of each said first fitting engages a separately said joined hose and ring member in sealed-tight fixed relation around said main body enabling the unrestrained rotational motion of said second and third fittings about each said respective main body.

6. The rotatable coupling assembly of claim 5 wherein said spaced apart radial projections of said second fitting lockingly engage said hook-like members formed in the fitting of said recreational vehicle discharge outlet coupling member.

7. The rotatable coupling assembly of claim 5 wherein said spaced apart radial projections of said second fitting lockingly engage said hook-like members formed in the fitting of said coupling member of said external waste disposal receptacle inlet.

8. The rotatable coupling assembly of claim 5 wherein said hook-like members of said third fitting lockingly engage said spaced apart radial projections formed in the fitting of said recreational vehicle waste discharge outlet coupling member.

9. The rotatable coupling assembly of claim 5 wherein said hook-like members of said third fitting lockingly engage said spaced apart radial projections formed in the fitting of said coupling member of said external waste disposal receptacle inlet.

10. A rotatable coupling assembly for facilitating the connection and separation of a waste discharge hose, said hose having end portions and an opening at either end, between a recreational vehicle waste discharge outlet and the inlet of an external waste disposal receptacle, comprising:
a first fitting having a generally cylindrical main body with a first outer circumferential dimension, a first end and a second end, said first end being substantially axially aligned with said main body and said second end having a flanged portion;
a second fitting having an inner edge, an outer edge, an outside surface, and an opening with a second circumferential dimension adapted to fit over said first end of said first fitting and slide along said main body until said inner edge comes close to or abuts said flanged portion of said first fitting, said second fitting having spaced apart radial projections for engaging in a locking relation corresponding hook like members of a mating fitting;
a flanged ring member with an annular seating surface, said seating surface being fixedly joined to one of said hose end portions, having an opening with a circumferential dimension substantially the same as said second circumferential dimension of said second fitting opening adapted to be slidably disposed along said main body until it approaches said outer edge of said second fitting in close or abutting relation; and,
wherein said second fitting engages said first end of said first fitting and is moved in slidable relation along said cylindrical main body until said second fitting comes close to or abuts said flanged portion of said first fitting, and said first end of said first fitting engages the opening formed by said joined ring member and hose end in a sealed-tight fixed relation enabling said second fitting to freely rotate about said main body.

11. A rotatable coupling assembly for facilitating the connection and separation of a waste discharge hose, said hose having end portions and an opening at either end, between a recreational vehicle discharge outlet and the inlet of an external waste disposal receptacle, comprising:
a first fitting having a generally cylindrical main body with a first outer circumferential dimension, a first end and a second end, said first end being substantially axially aligned with said main body and said second end having a flanged portion;
a second fitting having an inner edge, an outer edge, an outside surface, and an opening with a second circumferential dimension adapted to fit over said first end of said first fitting and slide along said main body until said inner edge comes close to or abuts said flanged portion of said first fitting, said second fitting having two or more hook-like members integrally formed therewith for engaging in a locking relation corresponding radial projections of a mating fitting;
a flanged ring member with an annular seating surface, said seating surface being fixedly joined to one of said hose end portions, having an opening with a circumferential dimension substantially the same as said second circumferential dimension of said second fitting opening adapted to be slidably disposed along said main body until it approaches said outer edge of said second fitting in close or abutting relation; and,
wherein said second fitting engages said first end of said first fitting in slidable relation along said cylindrical main body until said second fitting comes close to or abuts said flanged portion of said first fitting, and said first end of said first fitting engages the opening formed by said joined ring member and hose end in a sealed-tight fixed relation enabling said second fitting to freely rotate about said main body.

12. A rotatable coupling assembly for facilitating the connection and separation of a waste discharge hose, said hose having end portions and an opening at either end, comprising:
a first fitting having a main body with a first end and a second end;
a second fitting having a first mating means for engaging in a locking relation corresponding second mating means of a mated fitting;
a ring member with an annular seating surface, said seating surface being joined to one of said hose end portions, having an opening adapted to engage and be slidably disposed along said main body until it approaches said second fitting in close or abutting relation; and,
wherein said second fitting engages said first end of said first fitting and is moved in slidable relation along said main body until said second fitting comes close to or abuts said second end of said first fitting, and said first end of said first fitting engages the opening formed by said joined ring member and hose end in a sealed-tight fixed relation enabling laterally contained rotational movement of said second fitting about said main body.

13. The rotatable coupling assembly of claim 5, wherein said flanged portion of each said second end of each said first fitting includes a sealing gasket member.
